(19) United States
(12) Patent Application Publication
(10) Pub. No.: US 2008/0112658 A1
(43) Pub. Date: May 15, 2008

(54) Bushing for increased lubrication

(76) Inventor: William Justin, Palnt City, FL (US)

Correspondence Address: TY UNG, 16830 VENTURA BLVD., SUITE 360, ENCINO, CA, 91436, US

(21) Appl. No.: 11/985,689

(22) Filed: Nov. 15, 2007

Related U.S. Application Data
(60) Provisional application No. 60/859,061, filed on Nov. 15, 2006.

(51) Int. Cl. F16C 32/06

(52) U.S. Cl. 384/107

(57) ABSTRACT

The present invention relates to bushing used in bearings. The bushing of the present invention is cylindrical with grooves on its inner face, and more particularly grooves which form a grid-like arrangement. Holes are located within the groove such that when lubricant is poured through the holes, it flows into the grooves. The grooves allow the flow of lubricant throughout the inner face, allowing the bushing and shaft assembly to stay lubricated longer and increasing its life.

### CROSS-REFERENCE TO RELATED APPPLICATION

This application claim priority to provisional application No. 60/859,061 filed on Nov. 15, 2006.

### FEDERALLY SPONSORED RESEARCH

Not Applicable

### SEQUENCE LISTING OR PROGRAM

Not Applicable

### BACKGROUND OF THE INVENTION

The present invention relates to bushing, which is a replaceable tube or sleeve, mounted in a case or housing as a bearing. A bushing, more specifically, is a cylindrical lined mechanical device designed to reduce friction and wear, or constrict and restrain the motion of mechanical parts.

A typical bearing is made of two parts. For example a rotary plain bearing can be just a shaft running through a hole. A simple linear bearing can be a pair of flat surfaces designed to allow motion, for example a drawer and the slides it rests on.

Plain bearings may carry load in one of several ways depending on their operating conditions, load, relative surface speed, clearance within the bearing, quality of lubricant and temperature. If full-film conditions apply, the bearing's load is carried solely by a film of lubricant, there being no contact between the two bearing surfaces. In mix or boundary conditions, load is carried partly by direct surface contacts and partly by a film forming between the two. In a dry condition, the full load is carried by surface to surface contact.

Plain bearings are relatively simple and hence inexpensive. They are also compact, light weight, straightforward to repair and have high load-carrying capacity. However, if operating in dry or boundary conditions, plain bearings may wear faster and have higher friction than rolling element bearings. Dry and boundary conditions may be experienced even in a fluid bearing when operating outside of its normal operating conditions, i.e., at startup and shutdown.

Plain ‘self-lubricating’ bearings utilize porous journals within which a lubricant is held. As the bearing operates and lubricant is displaced from the bearing surface, more is carried in from non-wear parts of the bearing. Dry plain bearings can be made of a variety of materials including PTFE (Teflon), graphite, graphite/metal (Graphalloy), and ceramic. The ceramic is very hard, and sand and other grit which enter the bearing are simply ground to a fine powder which does not inhibit the operation of the bearing.

Solid polymer plain bearings are now increasingly popular due to dry-running lubrication-free behavior. Polymer plain bearings now provide the step from a simple plastic bushing to the proven and tested, and thereby predictable and quickly available, machine component. Solid polymer plain bearings give low weight and corrosion resistance.

Many companies produce bushings which consist of a metal shell which then has a very thin polymer coating (usually PTFE or similar) applied to the inside. Bushings are also used to transfer loads from a fastening to a much larger area in the underlying structure, the object being to reduce the strain on individual fibers within the underlying structure.

The present invention improves on existing bearings by providing a constant flow of lubrication through the bushing, The increase in lubrication limits the wear on the bearing and extends its life. Additionally, with the increase in lubrication, there is less maintenance required.

### SUMMARY OF THE INVENTION

The present invention relates to bushing used in bearings. The bushing of the present invention are cylindrical and more specifically, two identical semi-cylindrical parts. The inner face of the parts has longitudinal grooves and circumferential grooves, which form a grid-like arrangement. The longitudinal grooves are parallel to the axis of the cylinder and the circumferential grooves are along the inner circumference. The circumferential grooves are preferably broader and deeper than the longitudinal grooves. The part is also provided with at least one through hole on the face. The holes are located at the intersection of the grooves such that, when the lubricant is poured through the holes, it flows into the grooves. The grooves allow the flow of lubricant throughout the inner face, allowing the bushing and shaft assembly to stay lubricated longer and increasing its life.

### BRIEF DESCRIPTION OF THE FIGURES

FIG. 1 is a perspective view of the bushing.

FIG. 2 is a perspective view of the semi-cylindrical part.

FIGURES - REFERENCE NUMERALS

| | |
|---|---|
| 10 | Bushing |
| 12 | Semi-cylindrical Part |
| 14 | Longitudinal Groove |
| 16 | Circumferential Groove |
| 18 | Through Hole |

### DETAILED DESCRIPTION

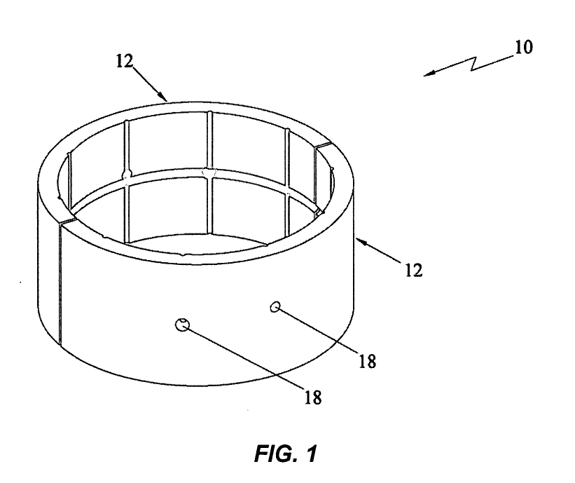

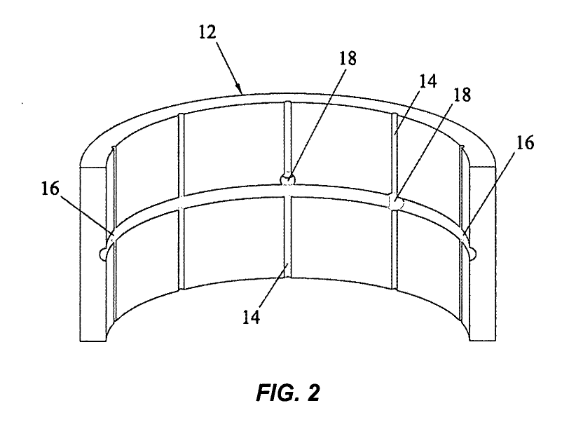

The novel features of the present invention will become apparent from the following description of a preferred embodiment of the invention and as illustrated in FIGS. 1 through 2. The present invention is a bearing bushing with lubricant dispersion grooves on its inner surfaces for better lubrication.

Referring to FIGS. 1 through 2, the bushing 10 comprises two identical semi-cylindrical parts 12. The inner face of the parts has longitudinal grooves 14 and circumferential grooves 16, which form a grid-like arrangement. The longitudinal grooves 14 are parallel to the axis of the cylinder and the circumferential grooves 16 are along the inner circumference. The circumferential grooves 16 are preferably broader and deeper than the longitudinal grooves 14. The bushing 10 is also provided with at least one through hole 18 on the face. The holes are located at the intersection of the grooves, 14 and 16, such that when the lubricant is poured through the holes 18, it flows into the grooves, 14 and 16.

Materials including Gatke (Phenolic resin), Nylatron GSM, UHMW can be used for making the bushing. Other materials such as PTFE (Teflon), graphite, graphite/metal (Graphalloy), and ceramic.

The two semi-cylindrical parts 12 are arranged coaxially over a shaft to form the cylindrical bushing 10. Lubricant or grease can then be poured through the holes 18. The grooves, 14 and 16, allow the flow of lubricant throughout the inner face, allowing the bushing 10 and shaft assembly to stay lubricated longer and increasing its life.

The bushing 10 of the present invention may be used to replace bushings currently used in bearings and is similarly designed except for the improvements discussed above.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

What is claimed is:

1. A bushing comprising:
At least one groove on the inner face of the bushing.

2. The busing of claim 1, wherein the bushing is cylindrical.

3. The bushing of claim 1, wherein the bushing comprises two identical semi-cylindrical parts.

4. The bushing of claim 2, wherein multiple grooves are arranged in a grid pattern.

5. The bushing of claim 4, wherein at least one hole is located at the intersection of the grooves.

6. The bushing of claim 3, wherein multiple grooves are arranged in a grid pattern.

7. The bushing of claim 6, wherein at least one hole is located at the intersection of the grooves.

8. The bushing of claim 1, wherein the bushing has a 9 inch inner diameter, 10 inch outer diameter, and a 5.5 inch length.

9. The bushing of claim 1, wherein the bushing has a 7 inch inner diameter, 8 inch outer diameter, and 4 5/16 inch length.

10. The bushing of claim 1, wherein the bushing is made of phenolic resin.

11. The bushing of claim 1, wherein the bushing is made of nylatron.

12. The bushing of claim 1, wherein the bushing is made of ceramic.

13. A use of bushing in bearings, wherein the bushing comprises:
At least one groove on an inner face of the bushing; and
At least one through hole in the groove.

14. The use of bushing in bearings 13, wherein multiple grooves are provided in a grid pattern on the inner face of the bushing and the at least one hole is located at the intersection of the grooves.

15. The use of bushing in bearings of claim 14, wherein the bushing is cylindrical.

16. The use of bushing in bearings of claim 14, wherein the bushing comprises two semi-cylindrical part.

17. The use of bushing in bearings of claim 13, wherein the bushing is made of ceramic.

18. The use of bushing in bearings of claim 16, wherein the bushing has a 7 inch inner diameter, 8 inch outer diameter, and 4 5/16 inch length.

19. The use of bushing in bearings of claim 16, wherein the bushing has a 9 inch inner diameter, 10 inch outer diameter, and a 5.5 inch length.

20. A method of using a bushing of the present invention comprising the step of:
(a) Arranging the bushing over a shaft; and
(b) Pouring lubricant through the holes.
